(19) United States
(12) Patent Application Publication
(10) Pub. No.: US 2008/0098436 A1
(43) Pub. Date: Apr. 24, 2008

(54) Top recording events list for media device

(75) Inventor: Scott White, Austin, TX (US)

Correspondence Address: SCHWEGMAN, LUNDBERG & WOESSNER, P.A., P.O. BOX 2938, MINNEAPOLIS, MN, 55402, US

(73) Assignee: SBC Knowledge Ventures, L.P.

(21) Appl. No.: 11/583,632

(22) Filed: Oct. 19, 2006

(51) Int. Cl. H04N 7/173; G06F 13/00; H04N 5/445; G06F 3/00

(52) U.S. Cl. 725/58; 725/113; 725/112

(57) ABSTRACT

In one embodiment, a method comprises extracting future event recording selections scheduled on a plurality of media devices. Each of the plurality of media devices is coupled through a private access network to a service provider and includes a digital video recorder. The method further comprises aggregating recorded data based on the scheduled future event recording selections; and generating a top recording events list based on the aggregated recorded data for transmission to a selected media device of the plurality of media devices.

### FIELD

The application relates generally to the field of multimedia processing, and more specifically to top recording events list based on aggregate data from a plurality of media devices and published on a display of a media device.

### BACKGROUND

Program events may be scheduled for recording on a digital video recorder using the digital video recorder and, in some instances, using a web site. Using the web site to schedule the recording may be quite convenient, especially when the user may not be in the presence of the actual digital video recorder. The web site may not be directly connected to the digital video recorder (DVR). Events scheduled for recording through the web site may not be actually scheduled on the DVR for some time. For example, the events may not be scheduled until up to about 36 hours later, for instance, depending upon the next successful connection between the service provider and the web service, and the next successful connection between the service provider and the DVR. Program events being broadcast before the actual scheduling occurs will simply not be recorded. Therefore, scheduling through a web site, while convenient, may not be successful. Further, in some instances, immediate access to the Internet may not be available for the user. The user may then forget to schedule the event.

### BRIEF DESCRIPTION OF DRAWINGS

An example embodiment of the present invention is illustrated by way of example and not limitation in the figures of the accompanying drawings, in which like references indicate similar elements and in which:

FIG. 1 illustrates an Internet Protocol Television (IPTV) system environment in which one embodiment may be implemented.

FIGS. 2 and 3 illustrate interfaces associated with a media device according to example embodiments.

FIG. 4 illustrates an interactive flow chart that demonstrates a method taking place on both the client side and the service provider side, according to an embodiment.

FIG. 5 shows a diagrammatic representation of machine in the example form of a computer system within which a set of instructions, for causing the machine to perform any one or more of the methodologies discussed herein, may be executed.

### DETAILED DESCRIPTION

In one embodiment, a method comprises extracting future event recording selections scheduled on a plurality of media devices. Each of the plurality of media devices is coupled through a private access network to a service provider and includes a digital video recorder. The method further comprises aggregating recorded data based on the scheduled future event recording selections; and generating a top recording events list based on the aggregated recorded data for transmission to a selected media device of the plurality of media devices.

In the following description, for the purposes of explanation, numerous specific details are set forth in order to provide a thorough understanding of the disclosed embodiments. It will be apparent, however, to one skilled in the art that the disclosed embodiments may be practiced without some of these specific details. In other instances, well-known structures and devices are shown in block diagram form.

### Example Internet Protocol Television System Environment

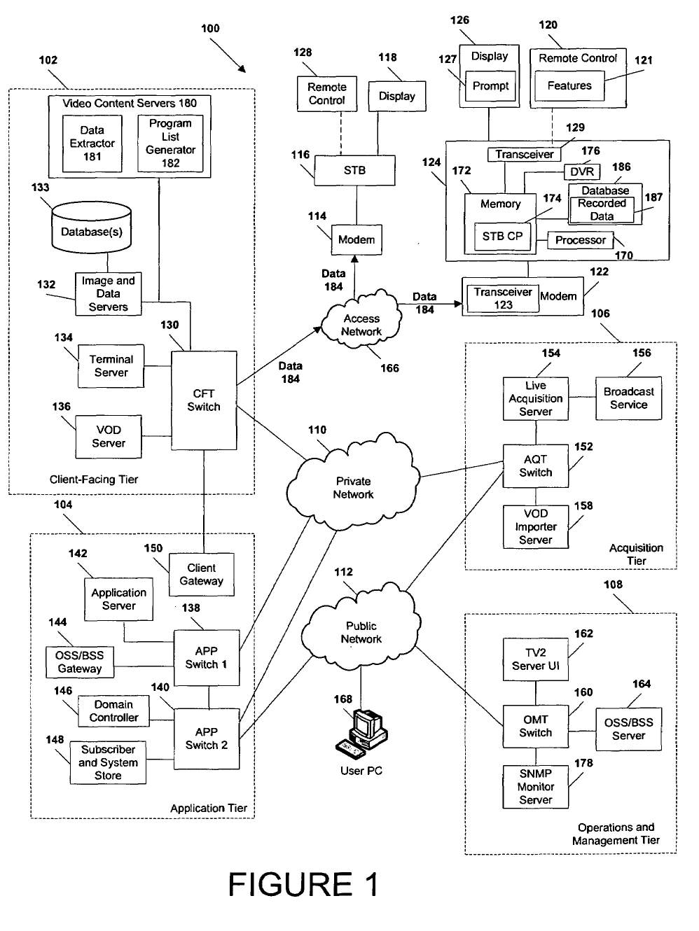

Referring to FIG. 1, an illustrative embodiment of an Internet Protocol Television (IPTV) system that may be used to provide video content is illustrated and is generally designated 100. As shown, the system 100 may include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 may be coupled to the private network 110. Further, the application tier 104 may be coupled to the private network 110 and to the public network 112. The acquisition tier 106 may also be coupled to the private network 110 and to the public network 112. Additionally, the operations and management tier 108 may be coupled to the public network 112.

As illustrated in FIG. 1, the various tiers 102, 104, 106, 108 communicate with each other via the private network 110 and the public network 112. For instance, the client-facing tier 102 may communicate with the application tier 104 and the acquisition tier 106 via the private network 110. The application tier 104 may also communicate with the acquisition tier 106 via the private network 110. Further, the application tier 104 may communicate with the acquisition tier 106 and the operations and management tier 108 via the public network 112. Moreover, the acquisition tier 106 may communicate with the operations and management tier 108 via the public network 112. In a particular embodiment, elements of the application tier 104, including, but not limited to, a client gateway 150, may communicate directly with the client-facing tier 102.

As illustrated in FIG. 1, the client-facing tier 102 may communicate with user equipment via a private access network 166, such as an Internet Protocol Television (IPTV) access network. In an illustrative embodiment, modems, such as a first modem 114 and a second modem 122 may be coupled to the private access network 166. The client-facing tier 102 may communicate with a first representative media device 116 via the first modem 114 and with a second representative media device 124 via the second modem 122, for instance.

The private access network 166, in one embodiment, is not an open Internet or web connection. The media device(s) are self-contained, and include data files and executable files to operate, display, and/or record. The service provider 180 transmits any data or executable files to the media device through the private access network. The self-contained media device receives periodic updates of the top recording events list through the private access network 166. In other embodiments, the media device is not self-contained and has an open web connection to view the top recording events list on the display. In this embodiment, because of the open Internet or web connection, updates to the top recording events may be substantially instantaneous at the display.

Each modem 114, 122 may include a transceiver, such as transceiver 123 of modem 122, to receive and send data 184, for instance. The data 184 received may include video content and/or time code data. The time code data may include, for instance, a start time of a program, an end time of a program, a channel or access point of a program, a code associated with the program (e.g., VCR+® code), and any other information that may be useful in recording a program or in determining access to a recorded program.

The transceiver 123 may receive the video content from a video content server 180 (or a service provider) on a first band channel, and may receive time code data from the service provider on a second band channel that is lower than the first band channel. Embodiments herein may work with different band channel systems that combine higher quality band channels with narrower band channels, such as AT&T's HomeZone® (combining Satellite with DSL) and StarMax® (combining Satellite with WiMax), for example. The video content may be sent on a high quality band channel, such as from a satellite source, cable source, IPTV source, on-air source, or any other suitable source. The time code data may be sent via phone, DSL, WiMax, cable source, wireless source, IPTV source, satellite source, on-air source, or any other suitable source. The time code data and/or the video content may be sent with an electronic program guide (EPG).

Because of the different band channels, the time code data may be transmitted to the user separately from the video content. In another embodiment, the time code data may be embedded in, and transmitted with, the video (e.g., in one of the lines in the vertical blanking interval for analog TV, or in the MPEG user data for digital TV).

The lower bandwidth bi-directional communications link may send and/or receive data. For example, through the transceiver 123, the media device 124 may transmit information to a video content server 180 about what program the user is or has viewed to use, for example, in a customized web page, as discussed herein. The information concerning viewed programming may be sent through either the lower or higher bandwidth communications link.

Additionally or alternatively to the content servers 180, data 184 may be generated, associated, and provided by an outside database, the device 116, 124, and/or a user of the device 116, 124, in other embodiments not shown.

The client-facing tier 102 may communicate with a large number of set-top boxes, such as the representative set-top boxes 116, 124, over a wide geographic area, such as a regional area, a metropolitan area, a viewing area, a designated market area or any other suitable geographic area, market area, or subscriber or customer group that may be supported by networking the client-facing tier 102 to numerous set-top box devices. In an illustrative embodiment, the client-facing tier, or any portion thereof, may be included at a video head-end office.

The media device 116/124 may include a cable box, a set-top box, a transmitter, a multifunctional device, a DVR, a television, a mobile device (such as a mobile phone), a video cassette recorder, a personal computer, a multifunctional device, an image recorder (e.g., for pictures), an audio recorder (e.g., for satellite radio), or any other media device. The media device may include a user interface for IPTV on a display 126, for instance.

In a particular embodiment, the client-facing tier 102 may be coupled to the modems 114, 122 via fiber optic cables. Alternatively, the modems 114 and 122 may be digital subscriber line (DSL) modems that are coupled to one or more network nodes via twisted pairs, and the client-facing tier 102 may be coupled to the network nodes via fiber-optic cables. Each set-top box device 116, 124 may process data received via the private access network 166, via an IPTV software platform, such as Microsoft® TV IPTV Edition.

Additionally, the first set-top box device 116 may be coupled to a first external display device 118, such as a first television monitor, and the second set-top box device 124 may be coupled to a second external display device 126, such as a second television monitor.

The set-top boxes 116, 124 may transmit the data 184 to an external display device, such as the display devices 118, 126 for displaying content, such as a broadcast program or event, for instance.

The first set-top box device 116 may communicate with the first remote control 128, and the second set-top box device may communicate with the second remote control 120. The device 116, 124 may include a wireless transceiver (e.g., transmitter and/or receiver) 129 to communicate with a wireless transmitter/receiver (not shown) of the remote controls 120, 128.

The remote controls 120, 128 may include multiple features or indicators 121 capable of being selected to connect and interact with the device 116, 124. The selections with regard to device modes of the media device, viewing an event, viewing a top recording events list, and/or recording an event may be made using features of one of the remote controls 120, 128, as described in more detail herein. The set-top box devices 116, 124 may communicate commands (i.e., to view a particular broadcast program) received from the remote control devices 120, 128 to the client-facing tier 102 via the private access network 166.

Further, the set-top box devices 116, 124 may each include a STB processor, such as STB processor 170, and a STB memory device, such as STB memory 172, which is accessible to the STB processor 170. In one embodiment, a computer program, such as the STB computer program (STB CP) 174, may be embedded within the STB memory device 172.

The memory 172 of the device 116, 124 may be coupled with a database 186 including recorded data 187, e.g., video content locally recorded from a transmission by a service provider. Each set-top box device 116, 124 may also include a video content storage module, such as a digital video recorder (DVR) 176. The device may include the DVR, as shown in FIG. 1. In another embodiment, the DVR may be a network DVR.

The device 116, 124 further includes logic (e.g., STB CP 174) to process the time code data, to display the top recording events list upon an appropriate device mode selection, to facilitate selection of an event to be recorded, and to record selected content.

The client-facing tier 102 may also include one or more video content servers 180 that transmit video content requested by viewers via their set-top boxes 116, 124. In an illustrative embodiment, the video content servers 180 may include one or more multicast servers. The video content servers 180 may additionally or alternatively transmit audio content, and/or image content.

Recording data based on future event recording selections scheduled on a plurality of media devices may be aggregated by a data extractor 181 of a service provider 180. Each of the plurality of media devices is coupled through the private access network 166 to the service provider. A means for extracting future event recording selections scheduled on a plurality of media devices includes the data extractor 181. Also, a means for aggregating recorded data based on the scheduled future event recording selections includes the data extractor 181.

A top recording events list based on the aggregated recording data may be generated by a program list generator 182 of the service provider. A means for generating a top recording events list based on the aggregated recorded data includes the program list generator 182. The aggregated recording data is based on future event recording selections scheduled on the plurality of media devices coupled through the private access network to the service provider.

The top recording events list may be stored on a database 133 of the client-facing tier 102. The top recording events list may be updated, by the program list generator, as each of the plurality of media devices transmits scheduling data representing scheduled recording selections. The updated top recording events list may be transmitted to the media device(s) upon connection with the service provider. The connection may be periodic or intermittent in one embodiment, or the connection may be continuous or open in another embodiment. The top recording events list may include a plurality of category lists, e.g., a top recording sports events list, or a top recording family events list, a top recording movie events list, a top recording children events list, or any other category for a broadcast event.

The data associated with the information related to each viewed program (e.g., web links, recipes, transcripts, and other program specific information) may be extracted automatically by the data extractor 182 and stored on a database 133 of the video content server(s) 180. In an additional embodiment, the data may be extracted at the media device, wherein the media device includes a data extractor similar to the data extractor 182.

In the instance where there are multiple users for a single media device 124, settings may be selected to account for such instances. In this instance, multiple web pages associated with the media device 124 may be available based on pre-determined settings (e.g., each family member has a separate web page based on designated areas of interest), or based on program subject matter (e.g., children's programs, or day-time talk shows) or based on another method. There may also be a main customized web page for each media device 124, with links to several other customized web pages.

In an illustrative embodiment, the client-facing tier 102 may include a client-facing tier (CFT) switch 130 that manages communication between the client-facing tier 102 and the private access network 166 and between the client-facing tier 102 and the private network 110. The switch 130 may act as a transmitter to send the content, time code data, and/or the top recording events list to the media device. The means for transmitting the top recording events list to a media device of the plurality of media devices to publish the top recording events list on a display coupled with the media device includes the switch 130.

As shown, the CFT switch 130 is coupled to one or more image and data servers 132 for the database(s) 133. Means for storing data includes the database of at least one of the service provider and the media device. In one embodiment, the database 133 stores the time code data. The database(s) 133 may also store broadcast events and related information. The database(s) 133 may further store the top recording events list. In an illustrative embodiment, the image and data servers 132 may be a cluster of servers, each of which may store still images, channel and program-related data, or any combination thereof.

The CFT switch 130 may also be coupled to a terminal server 134 that provides terminal devices with a connection point to the private network 110. In a particular embodiment, the CFT switch 130 may also be coupled to a video-on-demand (VOD) server 136 that stores or provides VOD content imported by the IPTV system 100.

As illustrated in FIG. 1, the application tier 104 may communicate with both the private network 110 and the public network 112. The application tier 104 may include a first application tier (APP) switch 138 and a second APP switch 140. In a particular embodiment, the first APP switch 138 may be coupled to the second APP switch 140. The first APP switch 138 may be coupled to an application server 142 and to an OSS/BSS gateway 144. In a particular embodiment, the application server 142 may provide applications to the set-top box devices 116, 124 via the private access network 166, which enable the set-top box devices 116, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway 144 may provide or restrict access to an OSS/BSS server 164 that stores operations and billing systems data.

Further, the second APP switch 140 may be coupled to a domain controller 146 that provides web access, for example, to users via the public network 112. For example, the domain controller 146 may provide remote web access to IPTV account information via the public network 112, which users may access using their personal computers 168. The second APP switch 140 may be coupled to a subscriber and system store 148 that includes account information, such as account information that is associated with users who access the system 100 via the private network 110 or the public network 112. In a particular embodiment, the application tier 104 may also include a client gateway 150 that communicates data directly with the client-facing tier 102. In this embodiment, the client gateway 150 may be coupled directly to the CFT switch 130. The client gateway 150 may provide user access to the private network 110 and the tiers coupled thereto.

In a particular embodiment, the set-top box devices 116, 124 may access the IPTV system 100 via the private access network 166, using information received from the client gateway 150. In this embodiment, the private access network 166 may provide security for the private network 110. User devices may access the client gateway 150 via the private access network 166, and the client gateway 150 may allow such devices to access the private network 110 once the devices are authenticated or verified. Similarly, the client gateway 150 may prevent unauthorized devices, such as hacker computers or stolen set-top box devices from accessing the private network 110, by denying access to these devices beyond the private access network 166.

For example, when the first representative set-top box device 116 accesses the system 100 via the private access network 166, the client gateway 150 may verify subscriber information by communicating with the subscriber and system store 148 via the private network 110, the first APP switch 138, and the second APP switch 140. Further, the client gateway 150 may verify billing information and status by communicating with the OSS/BSS gateway 144 via the private network 110 and the first APP switch 138. In one embodiment, the OSS/BSS gateway 144 may transmit a query across the first APP switch 138, to the second APP switch 140, and the second APP switch 140 may communicate the query across the public network 112 to the OSS/BSS server 164. After the client gateway 150 confirms subscriber and/or billing information, the client gateway 150 may allow the set-top box device 116 access to IPTV content and VOD content. If the client gateway 150 cannot verify subscriber information for the set-top box device 116, e.g., because it is connected to an unauthorized twisted pair, the client gateway 150 may block transmissions to and from the set-top box device 116 beyond the private access network 166.

As indicated in FIG. 1, the acquisition tier 106 includes an acquisition tier (AQT) switch 152 that communicates with the private network 110. The AQT switch 152 may also communicate with the operations and management tier 108 via the public network 112. In a particular embodiment, the AQT switch 152 may be coupled to a live acquisition server 154 that receives television or movie content, for example, from a broadcast service 156. In a particular embodiment during operation of the IPTV system, the live acquisition server 154 may acquire television or movie content. The live acquisition server 154 may transmit the television or movie content to the AQT switch 152, and the AQT switch 152 may transmit the television or movie content to the CFT switch 130 via the private network 110.

Further, the television or movie content may be transmitted to the video content servers 180, where it may be encoded, formatted, stored, or otherwise manipulated and prepared for communication to the set-top box devices 116, 124. The CFT switch 130 may communicate the television or movie content (and the time code data and any top recording lists) to the modems 114, 122 via the private access network 166. The set-top box devices 116, 124 may receive the television or movie content via the modems 114, 122, and may transmit the television or movie content to the display devices 118, 126. In an illustrative embodiment, video or audio portions of the television or movie content may be streamed to the set-top box devices 116, 124.

In an example, non-limiting embodiment, each set-top box device 116, 124 may receive content data 184, which may include video content and/or audio content or portions thereof, from the client-facing tier 102 via the private access network 166. The content data 184 may be associated with at least one program, such as a broadcast program itself. Multiple programs may be broadcast through the content data 184 at any given time, each with their own program content data.

Further, the AQT switch may be coupled to a video-on-demand importer server 158 that stores television or movie content received at the acquisition tier 106 and communicates the stored content to the VOD server 136 at the client-facing tier 102 via the private network 110. Additionally, at the acquisition tier 106, the video-on-demand (VOD) importer server 158 may receive content from one or more VOD sources outside the IPTV system 100, such as movie studios and programmers of non-live content. The VOD importer server 158 may transmit the VOD content to the AQT switch 152, and the AQT switch 152, in turn, may communicate the material to the CFT switch 130 via the private network 110. The VOD content may be stored at one or more servers, such as the VOD server 136.

When users issue requests for VOD content via the set-top box devices 116, 124, the requests may be transmitted over the private access network 166 to the VOD server 136, via the CFT switch 130. Upon receiving such requests, the VOD server 136 may retrieve the requested VOD content and transmit the content to the set-top box devices 116, 124 across the private access network 166, via the CFT switch 130. The set-top box devices 116, 124 may transmit the VOD content to the display devices 118, 126. In an illustrative embodiment, video or audio portions of VOD content may be streamed to the set-top box devices 116, 124.

FIG. 1 further illustrates that the operations and management tier 108 may include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 may be coupled to an OSS/BSS server 164 and to a simple network management protocol (SNMP) monitor server 178 that monitors network devices within or coupled to the IPTV system 100. In a particular embodiment, the OMT switch 160 may communicate with the AQT switch 152 via the public network 112.

In an illustrative embodiment, the live acquisition server 154 may transmit the television or movie content to the AQT switch 152, and the AQT switch 152, in turn, may transmit the television or movie content to the OMT switch 160 via the public network 112. In this embodiment, the OMT switch 160 may transmit the television or movie content to the TV2 server 162 for display to users accessing the user interface at the TV2 server 162. For example, a user may access the TV2 server 162 using the personal computer (PC) 168 coupled to the public network 112.

### Example Interfaces

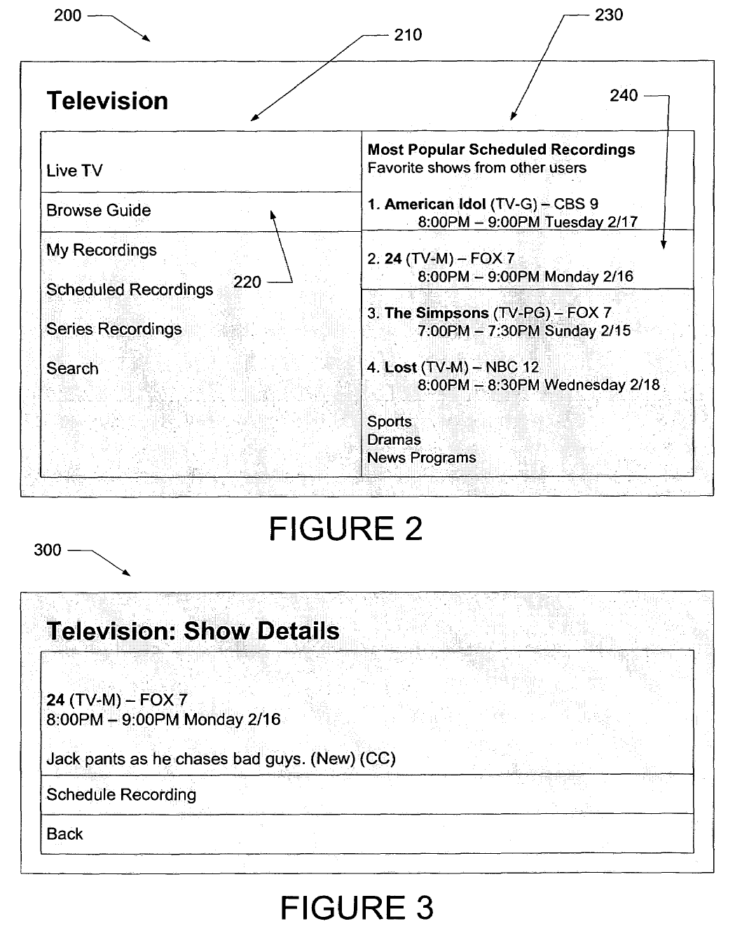

FIG. 2 illustrates an interface 200 of one of the media devices according to an example embodiment. The interface 200 may illustrate a first section or region 210 displaying several device modes of the media device for selection. In the embodiment shown, there are several device modes, including: Live TV (e.g., enabling a user to watch current television programming), Browse Guide (e.g., enabling a user to browse a list of current or future events to be watched and/or recorded), My Recordings (e.g., enabling a user to browse a list of recorded events), Scheduled Recordings (e.g., enabling a user to browse a list of events scheduled to be recorded), Series Recordings (e.g., enabling a user to browse a list of events having multiple episodes scheduled to be recorded), and Search (e.g., enabling a user to search for events in the Browse Guide, for recorded events, or for events to be recorded). These are sample device modes, and other device modes are within the scope of this description.

In a first mode of the display 126, the broadcasted events may be viewed or presented, for example, viewing the Live TV selection. In a second mode of the display 126, the browse guide, and in particular, the top recording events list may be presented or viewed as shown.

The device mode of “browse guide” 220 is selected in this embodiment shown. The top recording events list may be published on the display 126 upon selection of a user prompt 127 associated with the media device. The user prompt 127 may include the selection of the ‘browse guide’ device mode 220. The device mode may be selected by highlighting the device mode using controls of a remote control or a remote control feature, for instance. Upon selection of the browse guide device mode 220, the top recording events list may be published on the display at a second section or region 230.

The second section 230 may display information related to the selected device mode at the first section 210. In this embodiment, the browse guide 220 includes the “Most Popular Scheduled Recordings” List. This list may also be included with the top recording events list of the service provider. Several future program events may be listed in the second section 230. Each of the future program events may be selected by a remote control feature, for instance. In this instance, the program event “24” is selected at 240.

FIG. 3 illustrates an interface 300 of one of the media devices according to an example embodiment. When the program event 240 is selected, the interface 300 appears on the display 126 of the media device 124. The interface 300 may overlay interface 200 or may replace interface 200.

At interface 300, there are several user options, prompts, or selections with regard to the program event 240. The user may select to schedule a recording of the program event 240, may choose to receive further details about the program event, may choose to view the program event (if the event is currently being broadcast), or may choose to return to the previous screen, for instance.

### Flow Chart

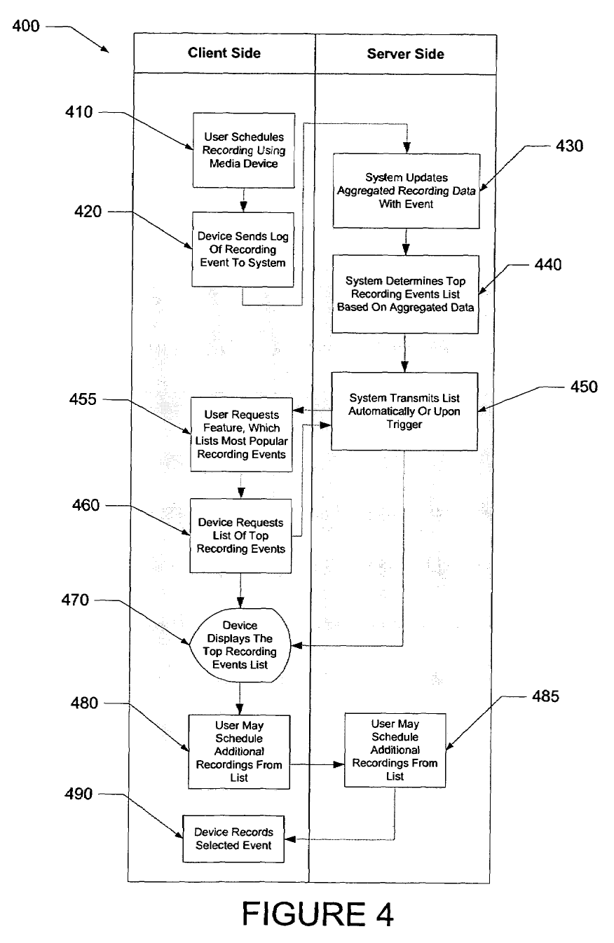

FIG. 4 illustrates an interactive flow chart that demonstrates a method 400 taking place on both the client side and the service provider side, according to an embodiment. The steps described below may be performed under the control of a programmed processor, such as processor 502 and/or processor 170, or the logic may be implemented and distributed among hardware, firmware, software, or a combination thereof within the DVR 176, for example.

At block 410, a user may schedule a recording using the media device, and in particular, scheduling a recording of an event on a DVR.

At block 420, the media device of the user may transmit a log of events recorded, or scheduled to be recorded, to the service provider system. The media device may transmit to the service provider 180 scheduling data associated with a scheduled recording selection from the top recording events list published on the display.

At block 430, on the server side, the system (service provider) may update aggregated recording data with the event(s) transmitted at block 420. The system may receive transmission from a plurality of media devices coupled through the private access network to the service provider.

At block 440, the system may determine the top recording events list based on the aggregated data of block 430.

At block 450, the system may transmit the list of block 440 to the media device(s). The list may be transmitted automatically to the individual media devices or upon a trigger. The list may be transmitted when the service provider connects with the media device, e.g., on a periodic basis, through the private access network. If the list is transmitted upon a trigger, the method flows to blocks 455, block 460, then back to block 450, then on to block 470. If the list is transmitted automatically, the method flows to block 470.

At block 455, on the client side, the user may request a DVR feature, which lists the most popular recording events. The DVR feature may include the browse guide device mode 220 of FIG. 2.

At block 460, the media device may request the list of top recording events from the service provider. The method may flow back to block 450 or to block 470.

At block 470, the media device displays the top recording events list on the interface as shown in FIG. 2, for instance.

At block 480, the user may schedule a recording from the top recording events list by using the interface as shown in FIG. 3, for instance.

At block 485, the service provider may receive the scheduling data associated with the scheduled recording selection at block 480 to schedule a recording on the media device.

At block 490, the media device may record the selected event.

### Computer Architecture

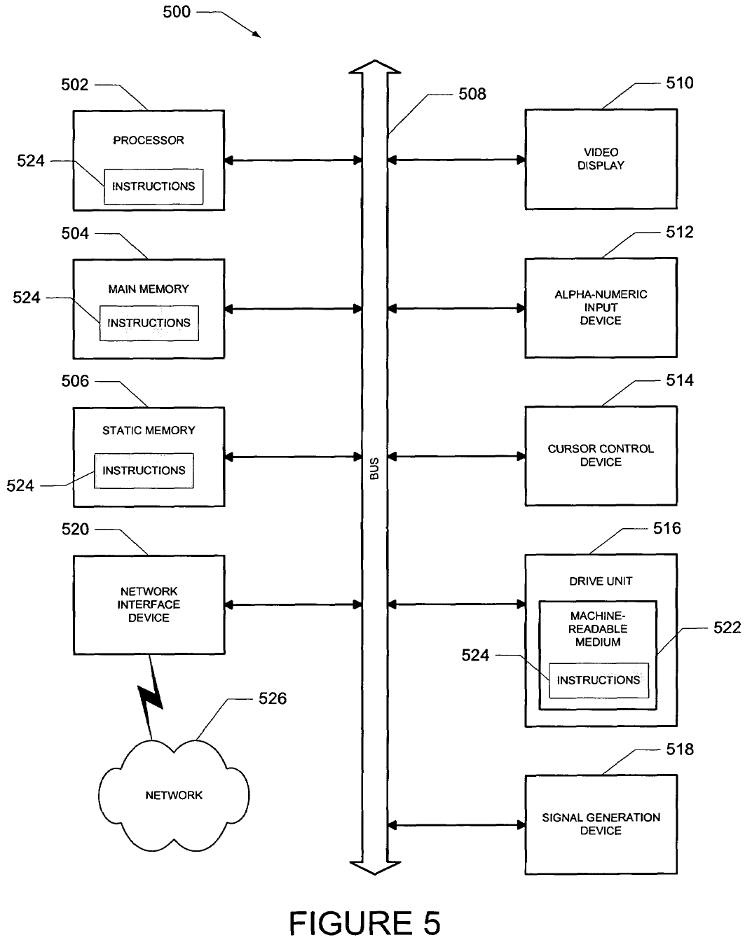

FIG. 5 shows a diagrammatic representation of a machine in the example form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a digital video recorder (DVR), a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The main memory 504 and/or the static memory 506 may be used to store the recorded programs and/or the look up tables.

The computer system 500 may further include a video display unit 510 (e.g., a television, a liquid crystal display (LCD) or a cathode ray tube (CRT)) on which to display broadcast or other programs, for example. The computer system 500 also includes an alphanumeric input device 512 (e.g., a keyboard or a remote control), a user interface (UI) navigation device 514 (e.g., a remote control, or a mouse), a disk drive unit 516, a signal generation device 518 (e.g., a speaker) and a network interface device 520.

The input device 512 and/or the navigation device 514 (e.g., the remote control) may include a processor (not shown), and a memory (not shown).

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 and/or the data stream 184 from the content provider may further be transmitted or received over a network 526 (e.g., a television cable provider) via the network interface device 520 utilizing any one of a number of well-known transfer protocols (e.g., broadcast transmissions, HTTP).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Therefore, methods and systems to generate and publish a top recording events list through a media device have been described. Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. An Internet Protocol Television server system comprising:
a data extractor of a service provider to aggregate recording data based on future event recording selections scheduled on a plurality of media devices, each of the plurality of media devices being coupled through a private access network to the service provider and including a digital video recorder;
a program list generator of the service provider to generate a top recording events list based on the aggregated recording data; and
a transmitter to transmit the top recording events list to a selected media device of the plurality of media devices to publish the top recording events list at the selected media device.

2. The system of claim 1 wherein the top recording events list is updated, by the program list generator of the service provider, as each of the plurality of media devices transmits data representing scheduled recording selections over the private access network to the service provider.

3. The system of claim 2 wherein the top recording events list is transmitted to the selected media device upon connection with the service provider through the private access network.

4. The system of claim 1 wherein the top recording events list includes a plurality of category lists.

5. A system comprising:
a particular media device of a plurality of media devices to record broadcasted events and to receive a top recording events list from a service provider based on aggregated recording data, wherein the aggregated recording data is based on future event recording selections scheduled on the plurality of media devices coupled through a private access network to the service provider, wherein the particular media device presents the broadcasted events in a first mode of the particular media device and presents the top recording events list in a second mode of the particular media device.

6. The system of claim 5 wherein the top recording events list is presented on a display coupled with the particular media device upon selection of a user prompt for the second mode of the particular media device, wherein a live television program is presented on the display upon selection of a user prompt for the first mode of the particular media device.

7. The system of claim 5 wherein an event of the top recording events list presented on a display coupled with the particular media device is scheduled to be recorded with the particular media device upon selection of a user prompt associated with the particular media device.

8. The system of claim 5 wherein the top recording events list includes a plurality of category lists.

9. A method comprising:
extracting future event recording selections scheduled on a plurality of media devices, each of the plurality of media devices being coupled through a private access network to a service provider and including a digital video recorder;
aggregating recorded data based on the scheduled future event recording selections;
generating a top recording events list based on the aggregated recorded data; and
transmitting the top recording events list to a particular media device of the plurality of media devices.

10. The method of claim 9 further comprising receiving scheduling data associated with a scheduled recording selection from the top recording events list to schedule a recording on the media device.

11. The method of claim 10 further comprising using the scheduling data to update the top recording events list.

12. A method comprising:
recording broadcasted events on a particular media device coupled through a private access network to a service provider;
receiving at the particular media device, from the service provider, a top recording events list based on aggregated recording data, wherein the aggregated recording data is based on future event recording selections scheduled by a plurality of media devices including the particular media device;
presenting the broadcasted events in a first mode of the particular media device; and
presenting the top recording events list in a second mode of the particular media device.

13. The method of claim 12 wherein the top recording events list is presented on a display coupled with the media device upon selection of a user prompt associated with the media device.

14. The method of claim 12 further comprising scheduling to record an event of the top recording events list with the particular media device upon selection of a user prompt associated with the particular media device.

15. The method of claim 12 wherein the top recording events list includes a plurality of category lists.

16. A machine readable medium having a set of instructions that, when executed by a machine, cause the machine to:
extract future event recording selections scheduled on a plurality of media devices, each of the plurality of media devices being coupled through a private access network to the service provider and including a digital video recorder;
aggregate recorded data based on the scheduled future event recording selections;
generate a top recording events list based on the aggregated recorded data; and
transmit the top recording events list to a particular media device of the plurality of media devices.

17. The medium of claim 16 further to receive scheduling data associated with a scheduled recording selection from the top recording events list presented on the display to schedule a recording on the particular media device.

18. The medium of claim 17 further to use the scheduling data to update the top recording events list.

19. The medium of claim 18 further to transmit the top recording events list to the particular media device upon connection with the service provider through the private access network.

20. The medium of claim 16 wherein the top recording events list includes a plurality of category lists.

21. A user interface associated with a digital video recorder comprising:
a first region having a selection guide with a plurality of device modes including a first device mode to present a live broadcasted programming event and a second device mode to present a top recording events list, the top recording events list received from a service provider based on aggregated recording data, wherein the aggregated recording data is based on future event recording selections scheduled on a plurality of media devices coupled through a private access network to the service provider; and
a second region to present the top recording events list upon selection of the second device mode.

22. The user interface of claim 21 wherein in the second region, a selection of an event of the top recording events list enables scheduling a recording of the event.

23. The user interface of claim 21 wherein the live broadcasted programming event program is presented through the media device upon selection of the first device mode.

24. The user interface of claim 21 wherein the top recording events list includes a plurality of category lists.
